(19) United States
(12) Patent Application Publication
(10) Pub. No.: US 2026/0338196 A1
(43) Pub. Date: Oct. 29, 2026

(54) SHAFT FOR TURBOCHARGER, AND TURBOCHARGER

(71) Applicant: IHI Corporation, Tokyo (JP)

(72) Inventors: Ryosuke MIYAO, Tokyo (JP); Naotoshi SHIMIZU, Tokyo (JP); Ryota SAKISAKA, Tokyo (JP)

(73) Assignee: IHI Corporation, Tokyo (JP)

(21) Appl. No.: 19/700,482

(22) Filed: Jun. 8, 2026

Related U.S. Application Data
(63) Continuation of application No. PCT/JP2025/010437, filed on Mar. 18, 2025.

(30) Foreign Application Priority Data
Apr. 22, 2024 (JP) 2024-069210

(51) Int. Cl. F04D 29/053; F02B 39/04; F04D 17/10; F04D 29/056

(52) U.S. Cl. CPC F04D 29/053; F02B 39/04; F04D 17/10; F04D 29/056

(57) ABSTRACT

A shaft for a turbocharger includes a first portion that is to be arranged in a bearing hole of a housing, wherein the bearing hole is isolated from a first space accommodating a turbine impeller and a second space accommodating a compressor impeller, and the first portion includes a coating that prevents hydrogen embrittlement on a surface that is to be in contact with a bearing arranged in the bearing hole.

### CROSS REFERENCE TO RELATED APPLICATIONS

This application is a continuation application of International Application No. PCT/JP2025/010437, filed on Mar. 18, 2025, which claims priority to Japanese Patent Application No. 2024-069210 filed on Apr. 22, 2024, the entire contents of which are incorporated herein by reference.

### BACKGROUND ART

### Technical Field

The present disclosure relates to a shaft for a turbocharger and a turbocharger.

For example, a turbocharger may be connected to an engine. For example, Patent Literature 1 discloses a hydrogen engine that includes a turbocharger.

### Citation List

### Patent Literature

Patent Literature 1: WO 2023/228570 A1

### SUMMARY

### Technical Problem

A turbocharger connected to a hydrogen engine may be exposed to hydrogen through various routes. Hydrogen may cause hydrogen embrittlement in components of a turbocharger.

The present disclosure aims to provide a shaft for a turbocharger and a turbocharger that can prevent hydrogen embrittlement.

### Solution to Problem

To solve the above problem, a shaft for a turbocharger according to one aspect of the present disclosure includes a first portion that is to be arranged in a bearing hole of a housing, the bearing hole being isolated from a first space accommodating a turbine impeller and a second space accommodating a compressor impeller, the first portion including a coating that prevents hydrogen embrittlement on a surface that is to be in contact with a bearing arranged in the bearing hole.

The shaft may include a second portion that is to be welded to the turbine impeller and that does not include the coating.

The shaft may include a third portion that is to be press-fitted into a central hole of the compressor impeller and that does not include the coating.

Another aspect of the present disclosure is a turbocharger including a turbine impeller, a compressor impeller, a bearing, a housing that includes a first space accommodating the turbine impeller, a second space accommodating the compressor impeller, and a bearing hole isolated from the first space and the second space and accommodating the bearing, and a shaft that is arranged in the housing and that is rotatably supported by the bearing, the shaft including a first portion that is arranged in the bearing hole and that includes a coating that prevents hydrogen embrittlement on a surface contacting the bearing.

The shaft may include a second portion that is welded to the turbine impeller and that does not include the coating.

The shaft may include a third portion that is press-fitted into a central hole of the compressor impeller and that does not include the coating.

The bearing may be a sliding bearing.

The turbocharger may include a thrust collar that is arranged around the shaft and that receives an axial load of the shaft, wherein a surface that receives the axial load in the thrust collar may include a material that prevents hydrogen embrittlement.

### Effects

According to the present disclosure, hydrogen embrittlement can be prevented.

### BRIEF DESCRIPTION OF DRAWINGS

FIG. 1 is a schematic cross-sectional view of a turbocharger.

FIG. 2 is a schematic enlarged cross-sectional view of area A in FIG. 1.

### DESCRIPTION OF EMBODIMENTS

An embodiment of the present disclosure will be described in detail below with reference to the accompanying drawings. Specific dimensions, materials, and numerical values described in the embodiment are merely examples for better understanding, and do not limit the present disclosure unless otherwise specified. In this specification and the drawings, duplicate explanations are omitted for elements having substantially the same functions and configurations by assigning the same sign. Furthermore, elements not directly related to the present disclosure are omitted from the figures.

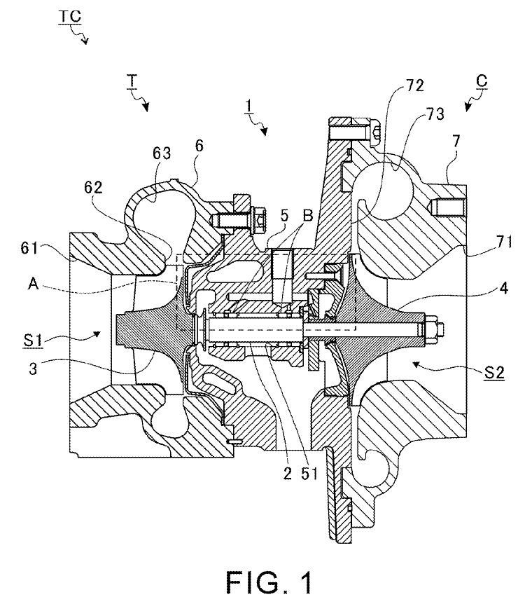

FIG. 1 is a schematic cross-sectional view of a turbocharger TC. The turbocharger TC is applied to a hydrogen engine (not shown). For example, the turbocharger TC includes a housing 1, a shaft 2, a turbine impeller 3, and a compressor impeller 4.

As will be described later, the turbine impeller 3 and the compressor impeller 4 rotate integrally with the shaft 2. Accordingly, in the present disclosure, axial directions, radial directions, and circumferential directions of the shaft 2, the turbine impeller 3, and the compressor impeller 4 may simply be referred to as the "axial direction," the "radial direction," and the "circumferential direction," respectively, unless otherwise specified. Furthermore, in the present disclosure, axes of the shaft 2, the turbine impeller 3, and the compressor impeller 4 may simply be referred to as the "axis," unless otherwise specified.

The housing 1 includes a bearing housing 5, a turbine housing 6, and a compressor housing 7. In the axial direction, one end of the bearing housing 5 is connected to the turbine housing 6. In the axial direction, the other end of the bearing housing 5 is connected to the compressor housing 7.

The bearing housing 5 includes a bearing hole 51. The bearing hole 51 extends in the axial direction within the bearing housing 5. The bearing hole 51 accommodates a bearing B. The bearing B rotatably supports the shaft 2. The shaft 2 passes through the bearing hole 51. The shaft 2 and the bearing B will be described in detail later.

In the axial direction, the turbine impeller 3 is provided at a first end of the shaft 2. The turbine impeller 3 rotates integrally with the shaft 2. The turbine housing 6 defines a first space S1 that accommodates the turbine impeller 3.

In the axial direction, the compressor impeller 4 is provided at a second end that is opposite to the first end

in the shaft 2. The compressor impeller 4 rotates integrally with the shaft 2. The compressor housing 7 defines a second space S2 that accommodates the compressor impeller 4.

The compressor housing 7 includes an inlet 71 at an end that is opposite to the bearing housing 5 in the axial direction. The inlet 71 is connected to an air cleaner (not shown).

The bearing housing 5 and the compressor housing 7 define a diffuser flow path 72 therebetween. The diffuser flow path 72 has an annular shape. The diffuser flow path 72 is located radially outside the compressor impeller 4. The diffuser flow path 72 is fluidically connected to the inlet 71 via the compressor impeller 4.

The compressor housing 7 includes a compressor scroll flow path 73. The compressor scroll flow path 73 is located radially outside the diffuser flow path 72. The compressor scroll flow path 73 is connected to the diffuser flow path 72. Furthermore, the compressor scroll flow path 73 is fluidically connected to an intake port of the hydrogen engine (not shown).

As the compressor impeller 4 rotates, air is sucked into the compressor housing 7 through the inlet 71. The air is accelerated and pressurized by centrifugal force while passing through the compressor impeller 4. The air is further pressurized as passing through the diffuser flow path 72, and flows into the compressor scroll flow path 73. The pressurized air flows out from an outlet opening (not shown), and is directed to the intake port of the hydrogen engine. In the turbocharger TC, a part including the compressor impeller 4 and the compressor housing 7 functions as a centrifugal compressor C.

The turbine housing 6 includes an outlet 61 at an end that is opposite to the bearing housing 5 in the axial direction. The outlet 61 is connected to an exhaust gas purifier (not shown).

The turbine housing 6 includes a connecting flow path 62. The connecting flow path 62 has an annular shape. The connecting flow path 62 is located radially outside the turbine impeller 3. The connecting flow path 62 is fluidically connected to the outlet 61 via the turbine impeller 3.

The turbine housing 6 includes a turbine scroll flow path 63. The turbine scroll flow path 63 is located radially outside the connecting flow path 62. The turbine scroll flow path 63 is connected to the connecting flow path 62. Furthermore, the turbine scroll flow path 63 is fluidically connected to a gas inlet opening (not shown). The gas inlet opening receives exhaust gas discharged from an exhaust manifold of the hydrogen engine.

The exhaust gas is directed from the gas inlet opening to the turbine scroll flow path 63, and further directed to the outlet 61 via the connecting flow path 62 and the turbine impeller 3. The exhaust gas rotates the turbine impeller 3 while passing through the turbine impeller 3. Rotational force of the turbine impeller 3 is transmitted to the compressor impeller 4 via the shaft 2. As the compressor impeller 4 rotates, air is pressurized as described above. As such, the pressurized air is directed to the intake port of the hydrogen engine. In the turbocharger TC, a part including the turbine impeller 3 and the turbine housing 6 functions as a turbine T.

Next, the shaft 2 and the bearing B will be described in detail.

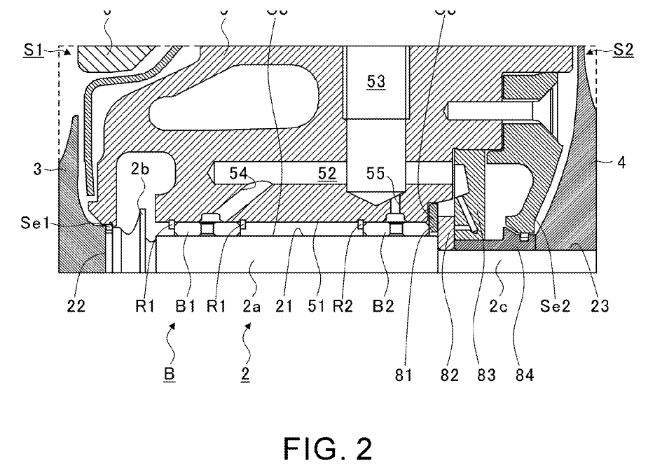

FIG. 2 is a schematic enlarged cross-sectional view of area A in FIG. 1.

In the present embodiment, a sliding bearing is used as the bearing B. Specifically, in the present embodiment, a full-floating bearing is used as the bearing B. In other embodiments, for example, a semi-floating bearing may be used as the bearing B.

In the present embodiment, the bearing B includes a first bearing B1 and a second bearing B2. The number of bearings B is not limited to two, and may be one or three or more. For example, in other embodiments, an integral sliding bearing may be used as the bearing B.

The first bearing B1 is arranged closer to the turbine impeller 3 with respect to the second bearing B2. The second bearing B2 is arranged closer to the compressor impeller 4 with respect to the first bearing B1. The first bearing B1 and the second bearing B2 are spaced apart from each other in the axial direction.

In the present embodiment, the first bearing B1 is supported in the axial direction by a pair of positioning rings R1 that are press-fitted into grooves formed on an inner circumferential surface of the bearing hole 51. In the present embodiment, the second bearing B2 is supported in the axial direction by a positioning ring R2 press-fitted into a groove formed on the inner circumferential surface of the bearing hole 51 and by a thrust bearing 81 (described later). In other embodiments, a sleeve may be arranged between the first bearing B1 and the second bearing B2 in place of the positioning rings R1 and R2.

The first bearing B1 and the second bearing B2 are supported in the radial direction by the inner circumferential surface of the bearing hole 51. In the present embodiment, since the first bearing B1 and the second bearing B2 are sliding bearings, the first bearing B1 and the second bearing B2 can slide in the circumferential direction with respect to the inner circumferential surface of the bearing hole 51. For example, the first bearing B1 and the second bearing B2 are made of a copper material such as brass.

The bearing housing 5 includes a main oil flow path 52. The main oil flow path 52 extends in the axial direction. The main oil flow path 52 extends parallel to the bearing hole 51. The main oil flow path 52 is located above the bearing hole 51.

The bearing hole 51 and the main oil flow path 52 are opened at a wall in the bearing housing 5. A bearing retainer 83 (described later) is mounted on the wall, and an opening of the main oil flow path 52 is closed by the bearing retainer 83.

The main oil flow path 52 is connected to a through hole 53. The through hole 53 is formed in the bearing housing 5. The through hole 53 extends from an outer wall of the bearing housing 5 to the main oil flow path 52. Oil used in the hydrogen engine is supplied from an oil pump (not shown) to the main oil flow path 52 via the through hole 53.

The bearing housing 5 includes a first oil flow path 54 and a second oil flow path 55. Each of the first oil flow path 54 and the second oil flow path 55 opens into the main oil flow path 52. Furthermore, each of the first oil flow path 54 and the second oil flow path 55 opens into the bearing hole 51. Each of the first oil flow path 54 and the second oil flow path 55 connects the main oil flow path 52 to the bearing hole 51. The first oil flow path 54 is provided at a position corresponding to the first bearing B1 and opens toward the first bearing B1. The second oil flow path 55 is provided at a position corresponding to the second bearing B2 and opens toward the second bearing B2. Accordingly, the first bearing B1 and the second bearing B2 are supplied with the oil used in the hydrogen engine.

The bearing hole 51 is fluidically isolated from the first space S1 accommodating the turbine impeller 3 by a seal Se1. The seal Se1 is arranged between the bearing hole 51 and the first space S1 in the axial direction. The seal Se1 is arranged between the shaft 2 and a wall of the bearing housing 5 in the radial direction. The bearing hole 51 is isolated from the exhaust gas flowing through the first space S1 by the seal Se1.

The bearing hole 51 is fluidically isolated from the second space S2 accommodating the compressor impeller 4 by a seal Se2. The seal Se2 is arranged between the bearing hole 51 and the second space S2 in the axial direction. The seal Se2 is arranged between an oil thrower 84 that is arranged around the shaft 2 and a wall of the bearing housing 5 in the radial direction. The bearing hole 51 is isolated from the air flowing through the second space S2 by the seal Se2.

The shaft 2 includes a middle-diameter section 2a, a large-diameter section 2b, and a small-diameter section 2c.

In the axial direction, the middle-diameter section 2a extends in an area that faces the bearing hole 51 in the radial direction. In the axial direction, the middle-diameter section 2a is positioned between the large-diameter section 2b and the small-diameter section 2c. The middle-diameter section 2a has a cylindrical shape. The middle-diameter section 2a is inserted into the first bearing B1 and the second bearing B2. The middle-diameter section 2a is supported by the first bearing B1 and the second bearing B2 in the radial direction. The middle-diameter section 2a is rotatably supported by the first bearing B1 and the second bearing B2. In the present embodiment, since the first bearing B1 and the second bearing B2 are sliding bearings, the middle-diameter section 2a is slidable with respect to the first bearing B1 and the second bearing B2 in the circumferential direction. The middle-diameter section 2a has a constant outer diameter. However, the outer diameter of the middle-diameter section 2a may not be constant.

In the axial direction, the large-diameter section 2b extends from a first end of the middle-diameter section 2a (an end closer to the turbine impeller 3) toward the first space S1. For example, the large-diameter section 2b has a substantially annular shape. An outer diameter of the large-diameter section 2b is larger than the outer diameter of the middle-diameter section 2a. For example, the outer diameter of the large-diameter section 2b is larger than the inner diameter of the bearing hole 51. For example, the large-diameter section 2b axially faces a wall of the bearing housing 5 that defines the bearing hole 51.

In the axial direction, the small-diameter section 2c extends from a second end of the middle-diameter section 2a (an end closer to the compressor impeller 4) toward the second space S2. The small-diameter section 2c has a cylindrical shape. An outer diameter of the small-diameter section 2c is smaller than the outer diameter of the middle-diameter section 2a. The small-diameter section 2c has a constant outer diameter. However, the outer diameter of the small-diameter section 2c may not be constant.

On the shaft 2, a thrust bearing 81, a thrust collar 82, the bearing retainer 83, and the oil thrower 84 are provided in this order between the second bearing B2 and the compressor impeller 4 in the axial direction from a side closer to the second bearing B2. The shaft 2 is inserted into the thrust bearing 81, the thrust collar 82, and the oil thrower 84.

The thrust bearing 81 is arranged adjacent to the second bearing B2 in the axial direction, and is in contact with the second bearing B2. Furthermore, in the axial direction, the thrust bearing 81 is in contact with a wall of the bearing housing 5 that defines the bearing hole 51. The thrust bearing 81 is arranged around the middle-diameter section 2a. The thrust bearing 81 has an annular shape. In the present embodiment, a sliding bearing is used as the thrust bearing 81. Accordingly, the thrust bearing 81 is slidable in the circumferential direction with respect to the wall of the bearing housing 5. For example, the thrust bearing 81 is made of a copper material such as brass.

The thrust collar 82 is arranged adjacent to the thrust bearing 81 in the axial direction, and is in contact with the thrust bearing 81. Furthermore, in the axial direction, the thrust collar 82 is in contact with a step between the middle-diameter section 2a and the small-diameter section 2c. The thrust collar 82 is arranged around the small-diameter section 2c. The thrust collar 82 has an annular shape.

The bearing retainer 83 is arranged adjacent to the thrust collar 82 in the axial direction, and is in contact with the thrust collar 82. The bearing retainer 83 is arranged around the oil thrower 84. Furthermore, the bearing retainer 83 is fixed to the bearing housing 5. Accordingly, the thrust bearing 81 and the thrust collar 82 are supported in the axial direction by the second bearing B2 and the bearing retainer 83. The bearing retainer 83 has an annular shape. The bearing retainer 83 includes an oil flow path for guiding a part of the oil flowing through the aforementioned main oil flow path 52 to the thrust collar 82.

The oil thrower 84 is arranged adjacent to the thrust collar 82 in the axial direction, and is in contact with the thrust collar 82. One end of the oil thrower 84 is arranged within the bearing retainer 83. The other end of the oil thrower 84 is arranged within the seal Se2. Furthermore, the other end of the oil thrower 84 is in contact with the compressor impeller 4 in the axial direction. The oil thrower 84 has a substantially cylindrical shape. Furthermore, the oil thrower 84 includes a substantially annular protrusion that extends in the radial direction.

Referring to FIGS. 1 and 2, the thrust collar 82, the oil thrower 84, and the compressor impeller 4 on the small-diameter section 2c are pressed against the step between the middle-diameter section 2a and the small-diameter section 2c by a bolt. Accordingly, the thrust collar 82, the oil thrower 84, and the compressor impeller 4 are fixed to the shaft 2 and rotate integrally with the shaft 2.

Referring to FIG. 2, when the shaft 2 moves toward the first space S1 in the axial direction, an axial load is supported by oil film pressure between the thrust bearing 81 and the thrust collar 82. When the shaft 2 moves toward the second space S2 in the axial direction, an axial load is supported by oil film pressure between the thrust collar 82 and the bearing retainer 83.

Referring to FIG. 1, as described above, the turbocharger TC is applied to the hydrogen engine. Accordingly, the turbocharger TC may be exposed to hydrogen through various routes.

For example, the turbine T receives the exhaust gas from the hydrogen engine. Accordingly, the components within the turbine T may be exposed to unburned hydrogen in the exhaust gas. However, in general, hydrogen engines operate primarily under lean-burn condition. Accordingly, it is expected that most of hydrogen is burned in the hydrogen engine, and a concentration of hydrogen in the exhaust gas is low.

In contrast, for example, the bearing hole 51 receives the oil used in the hydrogen engine. In the hydrogen engine, the oil is exposed to blow-by gas leaking from a gap between a piston and a cylinder. The blow-by gas may contain unburned hydrogen. Accordingly, it is expected that in the hydrogen engine, the oil absorbs hydrogen from the blow-by gas. In this case, the components within the bearing hole 51 may be exposed to the oil containing hydrogen. This may cause hydrogen embrittlement in the components within the bearing hole 51.

Referring to FIG. 2, in particular, the first bearing B1, the second bearing B2, and the thrust bearing 81 are sliding bearings as described above in the present embodiment. Accordingly, the bearings B1, B2, and 81 are slidable with respect to the surrounding components. As such, in the present embodiment, it is expected that hydrogen embrittlement may occur at sliding surfaces between the bearings B1, B2 and 81 and the surrounding components.

As described above, in the present embodiment, the first bearing B1, the second bearing B2, and the thrust bearing 81 are made of copper materials such as brass. In contrast, the components surrounding the bearings B1, B2 and 81 are made of steel. Although certain copper materials, such as tough-pitch copper, can cause hydrogen embrittlement, steel is generally considered to be more prone to causing hydrogen embrittlement than copper materials such as brass. Accordingly, in the present embodiment, among the components within the bearing hole 51, it is considered that hydrogen embrittlement is more likely to occur in the components that surround the bearings B1, B2 and 81. In particular, the shaft 2 may rotate at high speeds. Accordingly, it is expected that hydrogen embrittlement is more likely to occur on surfaces of the shaft 2.

To address such an issue, in the present embodiment, the shaft 2 includes a first portion 21.

The first portion 21 is located within the bearing hole 51. The first portion 21 includes surfaces that are in contact with the first bearing B1 and the second bearing B2. In the present embodiment, the first portion 21 includes a surface of the middle-diameter section 2a. The first portion 21 is provided with a coating Co that prevents hydrogen embrittlement. For example, such a coating Co may be a known coating containing ceramics. The coating Co is not limited thereto.

The shaft 2 includes a second portion 22. The second portion 22 includes an area connected to the turbine impeller 3. In the present embodiment, the shaft 2 is connected to the turbine impeller 3 by welding. Accordingly, the second portion 22 includes an area welded to the turbine impeller 3. In the present embodiment, the second portion 22 includes an end face in the axial direction of the large-diameter section 2b. For example, the welding may be electron beam welding. For example, the aforementioned coating containing ceramics may be non-conductive. If the second portion 22 includes such a coating, the shaft 2 may not be weldable to the turbine impeller 3. Accordingly, the second portion 22 does not include the coating Co.

The shaft 2 includes a third portion 23. The third portion 23 includes an area connected to the compressor impeller 4. In the present embodiment, the shaft 2 is connected to a central hole of the compressor impeller 4 by press-fitting. Accordingly, the third portion 23 includes an area that is press-fitted into the central hole of the compressor impeller 4. In the present embodiment, the third portion 23 includes a circumferential surface of the small-diameter section 2c. Specifically, in the present embodiment, the third portion 23 includes an area that is inserted into the thrust collar 82, the oil thrower 84, and the compressor impeller 4, in the small-diameter section 2c. For example, if the aforementioned coating is applied to the third portion 23, dimensional accuracy may deteriorate, and the shaft 2 may not be able to be inserted into the thrust collar 82, the oil thrower 84, and the compressor impeller 4. Accordingly, the third portion 23 does not include the coating Co.

For example, the shaft 2 may be manufactured by the following method. Firstly, the shaft 2 is formed from steel. For example, the shaft 2 may be formed by removal processing such as machining. Next, the coating Co is applied to the entire surface of the shaft 2. Subsequently, the coating Co is removed from the second portion 22 and the third portion 23 by removal processing such as grinding.

Alternatively, the shaft 2 may be manufactured by the following method. Firstly, the shaft 2 is formed from steel. For example, the shaft 2 may be formed by removal processing such as machining. Next, the second portion 22 and the third portion 23 are covered by masks. Subsequently, the coating Co is applied to the entire shaft 2, including the masked areas. Subsequently, the masks are removed from the second portion 22 and the third portion 23.

Furthermore, as described above, the thrust collar 82 rotates integrally with the shaft 2. In the present embodiment, at least an end face that is in contact with the thrust bearing 81 in the thrust collar 82 may include the coating Co that prevents hydrogen embrittlement, as similar to the first portion 21. Alternatively, the entire thrust collar 82 may be formed from a material that prevents hydrogen embrittlement. For example, such a material may be SUS316L. A material for preventing hydrogen embrittlement is not limited thereto.

The shaft 2 for the turbocharger TC according to the present embodiment as described above includes the first portion 21 that is to be arranged in the bearing hole 51 of the housing 1, wherein the bearing hole 51 is isolated from the first space S1 that accommodates the turbine impeller 3 and the second space S2 that accommodates the compressor impeller 4, and the first portion 21 includes the coating Co that prevents hydrogen embrittlement on the surface that is to be in contact with the bearing B arranged in the bearing hole 51. As described above, in the turbocharger TC applied to the hydrogen engine, it is expected that the components within the bearing hole 51 may cause hydrogen embrittlement due to the oil that has absorbed hydrogen from the blow-by gas. According to the above configuration, in the shaft 2, the first portion 21 that is arranged in the bearing hole 51 includes the coating Co that prevents hydrogen embrittlement. Accordingly, the aforementioned hydrogen embrittlement can be prevented.

Furthermore, the shaft 2 includes the second portion 22 that is to be welded to the turbine impeller 3 and that does not include the coating Co. As described above, the coating Co may be non-conductive. However, according to the above configuration, since the second portion 22 welded to the turbine impeller 3 does not include the coating Co, electrical conductivity between the turbine impeller 3 and the second portion 22 can be ensured during welding.

Furthermore, the shaft 2 includes the third portion 23 that is to be press-fitted into the central hole of the compressor impeller 4 and that does not include the coating Co. As described above, the coating Co may reduce dimensional accuracy. However, according to the above configuration, since the third portion 23 press-fitted into the central hole of the compressor impeller 4 does not include the coating Co, the third portion 23 can be easily inserted into the central hole of the compressor impeller 4 during assembly.

Furthermore, the turbocharger TC of the present embodiment includes the turbine impeller 3, the compressor impeller 4, the bearing B, the housing 1 that includes the first space S1 accommodating the turbine impeller 3, the second space S2 accommodating the compressor impeller 4, and the bearing hole 51 isolated from the first space S1 and the second space S2 and accommodating the bearing B, and the shaft 2 that is arranged in the housing 1 and that is rotatably supported by the bearing B. The shaft 2 includes the first portion 21 that is arranged in the bearing hole 51 and that includes the coating Co that prevents hydrogen embrittlement on the surface contacting the bearing B. According to such a configuration, in the shaft 2, hydrogen embrittlement of the first portion 21 arranged in the bearing hole 51 can be prevented, as described above.

Furthermore, in the turbocharger TC, the bearing B is a sliding bearing. Hydrogen embrittlement is more likely to occur at surfaces where components slide against one another. Accordingly, with the above configuration, hydrogen embrittlement of the shaft 2 that slides against the sliding bearing can be prevented.

Furthermore, the turbocharger TC includes the thrust collar 82 that is arranged around the shaft 2 and that receives an axial load of the shaft 2, wherein the surface of the thrust collar 82 that receives the axial load includes a material (coating Co or the entire thrust collar 82) that prevents hydrogen embrittlement. According to such a configuration, hydrogen embrittlement of the thrust collar 82 can be prevented.

Although an embodiment of the present disclosure has been described above with reference to the accompanying drawings, the present disclosure is not limited thereto. It is obvious that a person skilled in the art can conceive of various examples of variations or modifications within the scope of the claims, which are also understood to belong to the technical scope of the present disclosure.

For example, in the above embodiment, neither the second portion 22 nor the third portion 23 of the shaft 2 includes the coating Co. However, in other embodiments, at least one of the second portion 22 and the third portion 23 may include the coating Co. For example, if a reduction in dimensional accuracy due to the coating Co is not a concern, the coating Co may be left on the third portion 23.

The present disclosure can promote the use of hydrogen to reduce CO₂ emissions, thus contributing to Sustainable Development Goals (SDGs), Goal 7 "Ensure access to affordable, reliable, sustainable and modern energy," and Goal 13 "Take urgent action to combat climate change and its impacts," for example.

What is claimed is:

1. A shaft for a turbocharger, the shaft comprising:
a first portion that is to be arranged in a bearing hole of a housing, the bearing hole is isolated from a first space accommodating a turbine impeller and a second space accommodating a compressor impeller, the first portion including a coating that prevents hydrogen embrittlement on a surface that is to be in contact with a bearing arranged in the bearing hole.

2. The shaft for the turbocharger according to claim 1, wherein the shaft comprises a second portion that is to be welded to the turbine impeller and that does not include the coating.

3. The shaft for the turbocharger according to claim 1, wherein the shaft comprises a third portion that is to be press-fitted into a central hole of the compressor impeller and that does not include the coating.

4. A turbocharger comprising:
a turbine impeller;
a compressor impeller;
a bearing;
a housing that includes a first space accommodating the turbine impeller, a second space accommodating the compressor impeller, and a bearing hole isolated from the first space and the second space and accommodating the bearing; and
a shaft that is arranged in the housing and that is rotatably supported by the bearing, the shaft including a first portion that is arranged in the bearing hole and that includes a coating that prevents hydrogen embrittlement on a surface contacting the bearing.

5. The turbocharger according to claim 4, wherein the shaft includes a second portion that is welded to the turbine impeller and that does not include the coating.

6. The turbocharger according to claim 4, wherein the shaft includes a third portion that is press-fitted into a central hole of the compressor impeller and that does not include the coating.

7. The turbocharger according to claim 4, wherein the bearing is a sliding bearing.

8. The turbocharger according to claim 4, wherein the turbocharger comprises a thrust collar that is arranged around the shaft and that receives an axial load of the shaft, and
a surface that receives the axial load in the thrust collar includes a material that prevents hydrogen embrittlement.
